(19) United States
(12) Patent Application Publication
(10) Pub. No.: US 2010/0314058 A1
(43) Pub. Date: Dec. 16, 2010

(54) SANITARY TISSUE PRODUCTS COMPRISING DESIGN ELEMENTS

(76) Inventors: Matthew Todd Hupp, Cincinnati, OH (US); Guillermo Matias Vidal, Cincinnati, OH (US); Nicole Taylor, West Chester, OH (US); Brandy Nicole Lockaby, Cincinnati, OH (US); Oliver John Meinderding, Florence, KY (US); Sara Elizabeth Gordon, Cincinnati, OH (US); William Richard Rempe, Loveland, OH (US); Jill Marie Verkamp, Ludlow, KY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/797,729

(22) Filed: Jun. 10, 2010

Related U.S. Application Data
(60) Provisional application No. 61/186,484, filed on Jun. 12, 2009.

(51) Int. Cl. B31F 1/07; B31F 1/00

(52) U.S. Cl. 162/109

(57) ABSTRACT

Sanitary tissue products having two or more different regions of different design elements that provide weave patterns to surfaces of the sanitary tissue products and processes for making such sanitary tissue products are provided.

### CROSS REFERENCE TO RELATED APPLICATIONS

This application claims the benefit of U.S. Provisional Application No. 60/186,484 filed on Jun. 12, 2009.

### FIELD OF THE INVENTION

The present invention relates to sanitary tissue products comprising design elements and more particularly, to sanitary tissue products comprising two or more different regions of different design elements that provide weave patterns to surfaces of the sanitary tissue products.

### BACKGROUND OF THE INVENTION

Sanitary tissue products comprising design elements, such as embossments, protrusions, depressions and/or ink deposits, are known in the art. However, consumers of sanitary tissue products continue to desire more performance and/or perceived performance in their sanitary tissue products.

Formulators have been attempting to produce sanitary tissue products that are or appear to be stronger and/or more clothlike than known sanitary tissue products. Typically, as the strength of a sanitary tissue product increases, the softness of the sanitary tissue product decreases. Therefore, formulators have been focused primarily on producing sanitary tissue products that appear to be stronger and/or more clothlike than known sanitary tissue products.

Accordingly, there is a need for sanitary tissue products that appear to be stronger and/or more clothlike than known sanitary tissue products and methods for making same.

### SUMMARY OF THE INVENTION

The present invention fulfills the need described above by providing sanitary tissue products that appear to be stronger and/or more clothlike than known sanitary tissue products.

It has been found that sanitary tissue products that comprise a weave pattern are perceived by consumers of such sanitary tissue products as being stronger and/or more clothlike than sanitary tissue products without a weave pattern. In other words, the more a sanitary tissue product looks like a woven substrate, the more likely a consumer of the sanitary tissue product will perceive it as being stronger and/or more clothlike than a sanitary tissue product that does not look like a woven substrate.

In one example of the present invention, a sanitary tissue product comprising design elements that are arranged in two or more different regions is provided.

In another example of the present invention, a sanitary tissue product comprising two or more different design elements that are arranged in two or more different regions that are arranged to provide a weave pattern to a surface of the sanitary tissue product is provided.

In another example of the present invention, a sanitary tissue product comprising:

a. a first region defined by two or more design elements;

b. a second region defined by two or more design elements; and

c. a third region defined by two or more design elements;

wherein the first and third regions are positioned on different sides of the second region, wherein at least a portion of the second region defines only a portion of the first region and wherein the design elements of the second region are different from the design elements of the first and third regions such that the first region appears to extend underneath the second region to the third region, is provided.

In another example of the present invention, a process for making a sanitary tissue product comprising design elements, the process comprising the step of imparting a first region defined by two or more design elements, a second region defined by two or more design elements, and a third region defined by two or more design elements, wherein the first and third regions are positioned on different sides of the second region, wherein at least a portion of the second region defines a portion of the first region and a portion of the third region and wherein the design elements of the second region are different from the design elements of the first and third regions such that the first region appears to extend underneath the second region to the third region, is provided.

Accordingly, the present invention provides a sanitary tissue product comprising different design elements that are arranged into different regions in the sanitary tissue product and a process for making such sanitary tissue product.

### BRIEF DESCRIPTION OF THE DRAWINGS

FIG. 1 is a top plan view of an example of a sanitary tissue product according to the present invention;

FIG. 2 is a top plan view of an example of a sanitary tissue product according to the present invention; and

FIG. 3 is a top plan view of an example of a sanitary tissue product according to the present invention.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous materials such as fillers and adhesives used to facilitate the original papermaking

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises a fibrous structure according to the present invention.

The sanitary tissue products and/or fibrous structures of the present invention may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprise additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Design elements” as used herein means embossments (dot and/or line element embossments), protrusions, depressions, tufts and/or ink deposits.

“Weave pattern” as used herein means a plurality of different regions defined by design elements wherein the regions intersect one another at generally right angles and provide the appearance that one region extends underneath another region in one area and the same region extends over another region in another area of a pattern present on a surface of a sanitary tissue product.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Line element embossment” as used herein means an embossment that comprises a continuous line that has an aspect ratio of greater than 1.5:1 and/or greater than 1.75:1 and/or greater than 2:1 and/or greater than 5:1. In one example, the line element embossment exhibits a length of at least 2 mm and/or at least 4 mm and/or at least 6 mm and/or at least 1 cm to about 10.16 cm and/or to about 8 cm and/or to about 6 cm and/or to about 4 cm.

“Dot embossment” as used herein means an embossment that exhibits an aspect ratio of about 1:1. Non-limiting examples of dot embossments are embossments that are shaped like circles, squares and triangles.

### Sanitary Tissue Product

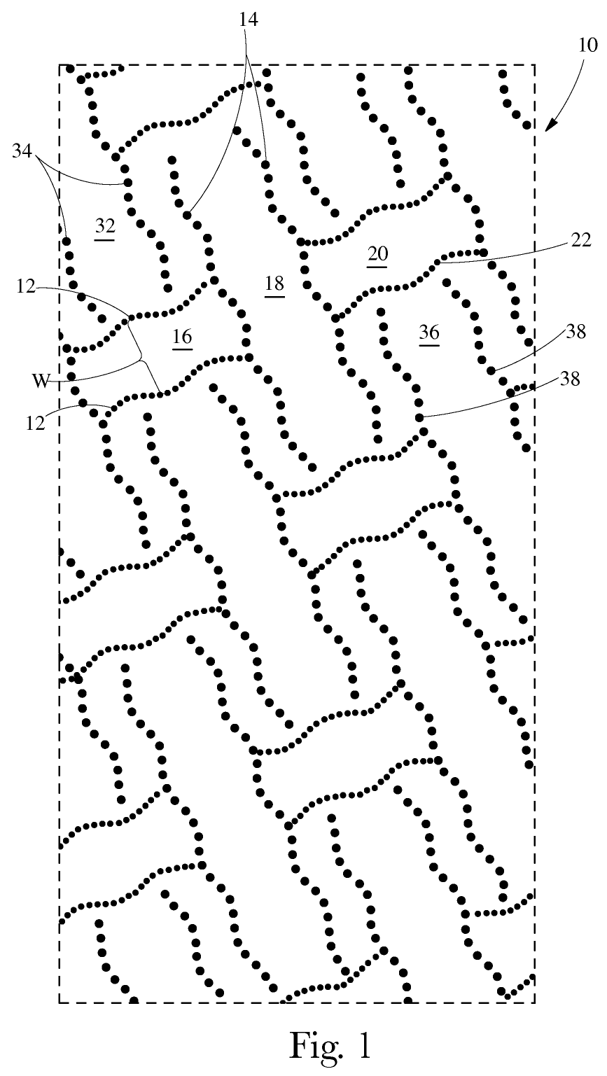

As shown in FIG. 1, a sanitary tissue product 10 according to the present invention comprises two or more different design elements 12 and 14, which may be embossments, protrusions, depressions and/or ink deposits. Design elements 12 may be arranged to define, at least in part, a first region 16. In the present example, the design elements 12 comprise a plurality of dot embossments that are arranged in two substantially parallel lines, which may be curvilinear lines. Design elements 14 may be arranged to define, at least in part, a second region 18. In the present example, the design elements 14 comprise a plurality of dot embossments that are arranged in two substantially parallel lines, which may be curvilinear lines. The two substantially parallel lines defining the second region 18 may be substantially perpendicular (for example intersecting at generally a right angle) to the two substantially parallel lines defining the first region 16.

A portion of the design elements 14 that define at least a portion of the second region 18 may also define a portion of the first region 16. In one example, the first region 16 appears to extend underneath the second region 18. In other words, the second region 18 appears to hide an extended portion of the first region 16.

The sanitary tissue product 10 may further comprise a third region 20 that is defined, at least in part, by two or more design elements 22. Design elements 22 may be the same or different from design elements 12. Design elements 22 are different from design elements 14.

The first, second, and third regions 16, 18, and 20 may be arranged such that the first region 16 and third region 20 are on different sides of the second region 18. In one example, the first region 16 and third region 20 are on opposing sides of the second region 18. The first region 16 and third region 20 may be arranged around the second region 18 such that the first region 16 appears to extend underneath the second region 18 and connect to the third region 20 to provide a weave pattern on the surface of the sanitary tissue product 10.

In one example, design elements 12, 14, and 20 may be dot embossments. Design elements 12 and 20 may dot embossments that are at least 10% and/or at least 15% and/or at least 20% smaller in surface area than the design elements 14.

In another example, one or more of the design elements 12, 14, and 20 may comprise ink deposits. Design elements 12 and 20 may be ink deposits that are at least 10% and/or at least 15% and/or at least 20% smaller in surface area than the design elements 14.

In another example, one or more of the design elements 12, 14, and 20 may comprise tufts that protrude off or in the sanitary tissue product 10. Design elements 12 and 20 may be tufts that are at least 10% and/or at least 15% and/or at least 20% smaller in surface area than the design elements 14.

In still another example, one or more of the design elements 12, 14, and 20 may comprise protrusions and/or depressions such as those formed on in a through-air-dried sanitary tissue product made on a fabric or molded belt.

As shown in FIG. 1, a sanitary tissue product 10 may comprise a first region 16 that is defined, at least in part, by two or more design elements 12. For example, the design elements 12 may comprise embossments, such as dot embossments. The design elements 12 may be arranged such that the first region 16 exhibits a maximum width W of greater than 5 mm and/or greater than 7 mm and/or greater than 10 mm and/or greater than 15 mm and/or greater than 20 mm to about 80 mm and/or to about 70 mm and/or to about 50 mm.

The first region 16 may also be defined, at least in part, by design elements 14, which are different, for example in shape, surface area, size, color, height, type (i.e., dot embossment versus line element embossment), from design elements 12.

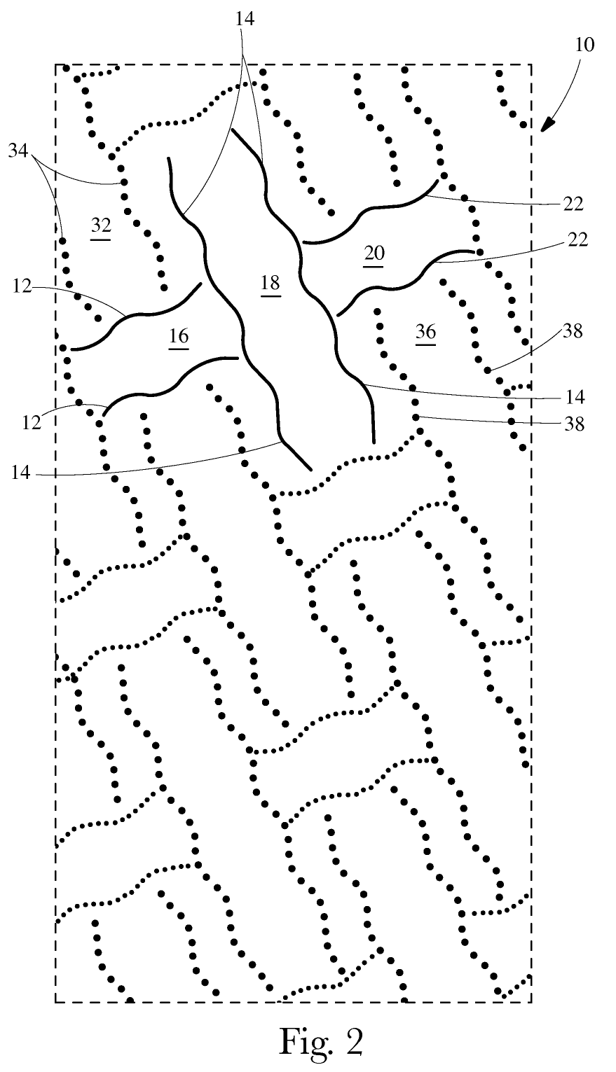

As shown in FIG. 2, another example of a sanitary tissue product 10 according to the present invention comprises a first region 16 defined, at least in part, by two or more design elements 12, which are line element embossments. Design elements 12 comprise two substantially parallel lines, which may be curvilinear line element embossments. Design elements 14, which are line element embossments, may be arranged to define, at least in part, a second region 18. In the present example, the design elements 14 comprise two substantially parallel lines, which may be curvilinear line element embossments. The two substantially parallel lines defining the second region 18 may be substantially perpendicular (for example intersecting at generally a right angle) two substantially parallel lines defining the first region 16.

A portion of the design elements 14 that define at least a portion of the second region 18 define a portion of the first region 16. The first region 16 may appear to extend underneath the second region 18. In other words, the second region 18 may appear to hide an extended portion of the first region 16.

The sanitary tissue product 10 may further comprise a third region 20 that is defined, at least in part, by two or more design elements 22. Design elements 22 may be the same or different from design elements 12. Design elements 22 are different from design elements 14.

The first, second, and third regions 16, 18, and 20 may be arranged such that the first region 16 and third region 20 are on different sides of the second region 18. In one example, the first region 16 and third region 20 are on opposing sides of the second region 18. The first region 16 and third region 20 may be arranged around the second region 18 such that the first region 16 appears to extend underneath the second region 18 and connect to the third region 20 to provide a weave pattern on the surface of the sanitary tissue product 10.

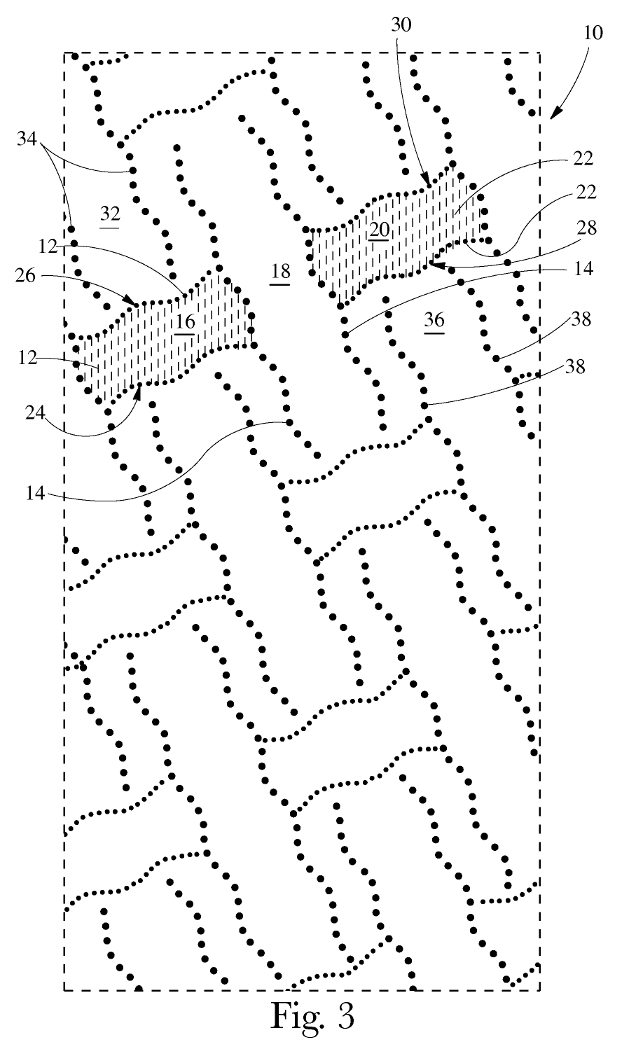

As shown in FIG. 3, another example of a sanitary tissue product 10 according to the present invention comprises a first region 16 defined, at least in part, by two or more design elements 12, which are a plurality of dot embossments. Design elements 12 may comprise a plurality of dot embossments grouped together to define the first region 16. The group of dot embossments may comprise a first edge 24 and an opposing second edge 26 that define, in part, the boundaries of the first region 16. Design elements 14, which are dot embossments, may be arranged to define, at least in part, a second region 18. In the present example, the design elements 14 comprise a plurality of dot embossments that are arranged in two substantially parallel lines, which may be curvilinear lines. The two substantially parallel lines defining the second region 18 may be substantially perpendicular (for example intersecting at generally a right angle) to the at least one of the first and second edges 24 and 26 of the first region 16.

A portion of the design elements 14 that define at least a portion of the second region 18 may define a portion of the first region 16. The first region 16 may appear to extend underneath of the second region 18. In other words, the second region 18 may appear to hide an extended portion of the first region 16.

The sanitary tissue product 10 may further comprise a third region 20 that is defined, at least in part, by two or more design elements 22 which are a plurality of dot embossments. Design elements 22 may comprise a plurality of dot embossments grouped together to define the third region 20. The group of dot embossments may comprise a first edge 28 and an opposing second edge 30 that define, in part, the boundaries of the third region 20. Design elements 22 may be the same or different from design elements 12. Design elements 22 are different from design elements 14.

The first, second, and third regions 16, 18, and 20 may be arranged such that the first region 16 and third region 20 are on different sides of the second region 18. In one example, the first region 16 and third region 20 are on opposing sides of the second region 18. The first region 16 and third region 20 may be arranged around the second region 18 such that the first region 16 appears to extend underneath the second region 18 and connect to the third region 20 to provide a weave pattern on the surface of the sanitary tissue product 10.

In another example, as shown in FIGS. 1 to 3, the first region 16 may be adjacent to a fourth region 32 defined, at least in part, by design elements 34 that are different from design elements 12. The fourth region 32 may be arranged such that the fourth region 32 appears to extend underneath the first region 16.

In another example, as shown in FIGS. 1 to 3, the third region 20 may be adjacent to a fifth region 36 defined, at least in part, by design elements 38 that are different from design elements 12. The fifth region 36 may be arranged such that the fifth region 36 appears to extend underneath the third region 20.

As shown in FIGS. 1 to 3, a sanitary tissue product 10 comprises a first region 16 defined, at least in part, by design elements 12, a second region 18 defined, at least in part, by design elements 14, and a fourth region 32 defined, at least in part, by design elements 34. The first, second and fourth regions 16, 18, and 32 may be arranged such that the first region 16 is, at least in part, defined by design elements 14 of the second region 18 and/or such that the fourth region 32 is, at least in part, defined by design elements 12 of the first region 16.

In one example, the first region 16 appears to extend underneath the second region 18 and over the fourth region 32.

The sanitary tissue product 10 of the present invention may comprise a non-random, repeating pattern of the first, second, and third regions 16, 18, and 20. In one example, at least 50% and/or at least 60% and/or at least 80% and/or to about 100% and/or to about 95% and/or to about 90% of the surface area of a surface of the sanitary tissue product comprises the weave pattern formed, at least in part, by the first, second, and third regions 16, 18, and 20.

In one example, the surface area of the design elements may be from about 0.25 mm² and/or from about 0.5 mm² and/or from about 0.75 mm² to about 20 mm² and/or to about 15 mm² and/or to about 10 mm² and/or to about 5 mm² and/or to about 3 mm².

In another example, the design elements of the present invention may exhibit different heights. The design elements may exhibit heights of from about 0 μm and/or from about 5 μm and/or from about 25 μm from about 50 μm and/or from about 100 μm to about 1200 μm and/or to about 1000 μm and/or to about 600 μm.

In yet another example, the design elements of the present invention may exhibit different colors, such as ink colors.

In addition to the design elements, the sanitary tissue product may comprise a discrete design, such as a floral representation, a animal representation and/or a geometric shape. In one example, the discrete design is positioned within one or more of the regions (defined by design elements) of the sanitary tissue product.

### Process for Making Sanitary Tissue Product

Any suitable process known in the art for imparting a pattern to a sanitary tissue product may be used to impart the design elements, for examples regions of design elements, into the sanitary tissue product of the present invention. For example, a sanitary tissue product may be subjected to an embossing operation wherein the design elements are imparted to the sanitary tissue product to provide a weave pattern on a surface of the sanitary tissue product.

In another example, a sanitary tissue product may be formed on a through-air-dried fabric or molded belt that imparts protrusions and/or depressions into a surface of the sanitary tissue product.

In still another example, the design elements may be imparted to a surface of the sanitary tissue product by printing the design elements onto the surface. Non-limiting examples of printing processes include rotogravure roll printing, flexographic printing and combinations thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sanitary tissue product comprising:
a. a first region defined by two or more design elements;
b. a second region defined by two or more design elements; and
c. a third region defined by two or more design elements;
wherein the first and third regions are positioned on different sides of the second region, wherein at least a portion of the second region defines only a portion of the first region and wherein the design elements of the second region are different from the design elements of the first and third regions such that the first region appears to extend underneath the second region to the third region.

2. The sanitary tissue product according to claim 1 wherein the second region defines only a portion of the third region.

3. The sanitary tissue product according to claim 1 wherein the first and third regions appear to be connected to one another underneath the second region.

4. The sanitary tissue product according to claim 1 wherein the first and third regions are positioned on opposite sides of the second region.

5. The sanitary tissue product according to claim 1 wherein the design elements comprise embossments.

6. The sanitary tissue product according to claim 5 wherein the embossments comprise a line element embossment.

7. The sanitary tissue product according to claim 5 wherein the embossments comprise a dot embossment.

8. The sanitary tissue product according to claim 1 wherein the design elements comprise tufts.

9. The sanitary tissue product according to claim 1 wherein the design elements comprise ink deposits.

10. The sanitary tissue product according to claim 1 wherein the design elements comprise a protrusion in a surface of the sanitary tissue product.

11. The sanitary tissue product according to claim 1 wherein the design elements comprise a depression in a surface of the sanitary tissue product.

12. The sanitary tissue product according to claim 1 wherein the design elements of the first region comprise dot embossments arranged in substantially parallel lines.

13. The sanitary tissue product according to claim 1 wherein the design elements of the third region comprise dot embossments arranged in substantially parallel lines.

14. The sanitary tissue product according to claim 1 wherein the design elements of the second region comprise dot embossments arranged in substantially parallel lines.

15. The sanitary tissue product according to claim 1 wherein the first region comprises a group of design elements.

16. The sanitary tissue product according to claim 1 wherein the third region comprises a group of design elements.

17. The sanitary tissue product according to claim 1 wherein the second region comprises a group of design elements.

18. The sanitary tissue product according to claim 1 wherein at least one of the first, second and third regions comprises a discrete design.

19. The sanitary tissue product according to claim 18 wherein the discrete design comprises a floral representation.

20. A process for making a sanitary tissue product comprising design elements, the process comprising the step of imparting a first region defined by two or more design elements, a second region defined by two or more design elements, and a third region defined by two or more design elements, wherein the first and third regions are positioned on different sides of the second region, wherein at least a portion of the second region defines a portion of the first region and a portion of the third region and wherein the design elements of the second region are different from the design elements of the first and third regions such that the first region appears to extend underneath the second region to the third region.
